(19) United States
(12) Patent Application Publication
(10) Pub. No.: US 2002/0091632 A1
(43) Pub. Date: Jul. 11, 2002

(54) Method and system for linking prepaid cards and calls using those cards to paying for content and other services over the internet

(76) Inventors: David L. Turock, Montclair, NJ (US); Richard A. Robbins, New York, NY (US); Warren S. Gifford, Holmdel, NJ (US)

Correspondence Address: James R. Klaiber, Esq., Milbank, Tweed, Hadley & McCloy LLP, 1 Chase Manhattan Plaza, New York, NY, 10005, US

(21) Appl. No.: 09/757,205

(22) Filed: Jan. 9, 2001

(51) Int. Cl. G06F 17/60

(52) U.S. Cl. 705/39

(57) ABSTRACT

A system and method of managing a prepaid card account to provide offers for goods and/or services in real time is provided. When a user establishes an electronic communication between the user and a service provider, and the service provider receives the user's prepaid card account card account number, the prepaid card account manager is notified. The prepaid account manager selects, and transmits, an offer of goods and/or services based on an interest database that corresponds to the user's prepaid card account, and the usage of that account.

### BACKGROUND OF THE INVENTION

Prepaid cards are often used by people who have particular personal interests. One typical use is to call relatives or friends in a particular country or countries. This is often based on a person's connection to a country, such as immigrating, or having friends and relatives in the country, or enjoying the culture or visiting the country. The prepaid card or account may reflect a specific country, such as the language on the card, special rates to one or more countries, or the language used in the telephone interaction. Another potential indication of interest is the organization issuing the card, such as an affinity group, or the content of the physical card itself, such as a sport or a hobby theme.

Often the location or locations called using the prepaid card also give an indication of particular interests, for example, when most calls are made to a particular country, or to a single telephone number in a country, or when specific services are called, such as information about a specific sport.

A user of a prepaid card may also be interested in information about the country or topic of interest reflected on the card or by calls using the card. For example, the user may have interest in accessing information over the Internet, such as radio and TV shows, or interacting with other people who share a similar interest, such as through a chat room, or having relevant items delivered to them, such as posters or books or CD's. Prior art systems have been proposed which use the nature of a telephone or internet transaction coupled with the identity of the user and the user's previous purchasing history to “upsell”, or present an offer of a second transaction, to the user before the first transaction is complete. These systems do not contemplate the utility of a prepaid card with such a system.

There is thus a need to provide the customer of a prepaid card with additional information, services, and products related to their interests and use of the prepaid card.

### SUMMARY OF THE INVENTION

A system and method of managing a prepaid card account to provide offers for goods and/or services in real time is provided. When a user establishes an electronic communication between the user and a service provider, and the service provider receives the user's prepaid card account card account number, the prepaid card account manager is notified. The prepaid account manager selects, and transmits, an offer of goods and/or services based on an interest database that corresponds to the user's prepaid card account.

### BRIEF DESCRIPTION OF THE DRAWINGS

FIG. 1 is a flow diagram depicting a telephone access embodiment of the present invention.

FIG. 2 is a flow diagram depicting an Internet access embodiment of the present invention.

FIG. 3 is a schematic diagram of the database and information flow of an embodiment of the present invention.

FIG. 4 is a flow diagram depicting an embodiment of the present invention for the user to manage the prepaid account using Internet access.

### DETAILED DESCRIPTION

This invention relates to a method and system for linking a prepaid card or account with telephone calls, Internet content and related services and products.

Certain aspects of this invention relate to paying for information, services, and products. Specific Internet content and related products and services, may be ordered over the Internet, and paid for using money on the prepaid card. Furthermore, specific Internet content and related products and services, may be ordered over the telephone, and paid for using money on the prepaid card. In addition, using the Internet interface a credit card or other method of payment can be used to add value to the prepaid card, either directly by the user or by someone on their behalf, such as a store or other sales agent or friend or relative.

This invention also relates to identifying interests of a user through use of a prepaid card. The physical prepaid card can contain the Internet address and other guidance or instructions or advertising to help the person find and access information, products and services over the telephone or the Internet. When a person uses a prepaid card to make calls to a particular country or to a service, such as soccer information, the number or numbers they call can be used to identify their interests. For example, the prepaid card could have been used to access a “900-number” so there is no record of the call on a telephone bill to cause embarrassment or auditing. When a person uses a prepaid card to purchase access to content over the Internet, or to purchase products and services, they are uniquely identified, and the characteristics of those purchases, as well as other information about their access, may be used to identify their interests.

Another aspect of the invention relates to applying identified interests of a user. Based on the interests identified, announcements may be played over the telephone to the card user making a call to alert them to appropriate Internet content, products and services, and to guide them in how to access and use these products and services; these announcements can either be generic to the interests, or can be tailored to the specific user, the specific time, or what the user has heard or selected, either currently or previously. Further, based on the identified interests, information can be shown on the Internet to the card user, such as content, products and services relating to the countries or topics of interest. Similarly, based on the interests identified, information, services or products can be given, shown or told to a user in a store, such as by a cashier or in an automated display, when they ask a question or are checking out, including giving them complimentary prepaid cards, relating to the countries or topics of interest. In addition, based on the interests identified, information can be sent to the user at home, office, hotel, resort, or at other locations, including sending a complimentary prepaid card, relating to the countries or topics of interest. The physical prepaid card may have particular features which are desired by the user, such as language, country, sport, or other subject matter, which guides the selection of content and the user interface on the Internet or the telephone.

Another aspect of the invention relates to managing the user's account. The user may make choices and enter information on the Internet in order to manage the account, for example, checking the current balance of the account, reviewing use of the account and adding value to the account. Furthermore, the user may make choices and enter information on the Internet that can guide the telephone usage of the account; for example, speed dial codes could be defined to make calling over the telephone faster, or special calling rates and plans can be selected. Similarly, the user may make choices and enter information on the Internet that can guide the Internet usage of the account; for example, choosing the types of information which will be available, arranging email delivery of information, and ordering content, products and services. Most, if not all, of these features can be provided over the telephone interface, but typically users find more complex interactions too difficult to do over a voice and touch tone interface, so they are rarely used even if they are made available. Thus simpler functions, such as checking the current value of the card are often available, while entering speed dial codes or selecting rate plans are not. Another difficulty is that if the user makes an error in the interaction, or if the call is cut off, etc., it may be difficult for the user to get the system back to an acceptable state, which is another reason to prefer a visual interface for these more complex functions.

During a telephone call, for example while waiting for a connection, during ringing, or at the end of a call, advertisements and other messages can be played to the caller to inform them of what is available on the Internet or other delivery. Because data are recorded on each caller and each call as part of the prepaid card, different messages may be played each time. If the content the caller has looked at, and used, on the Internet so the messages delivered on the telephone call are relevant to the caller's particular viewing experiences and preferences.

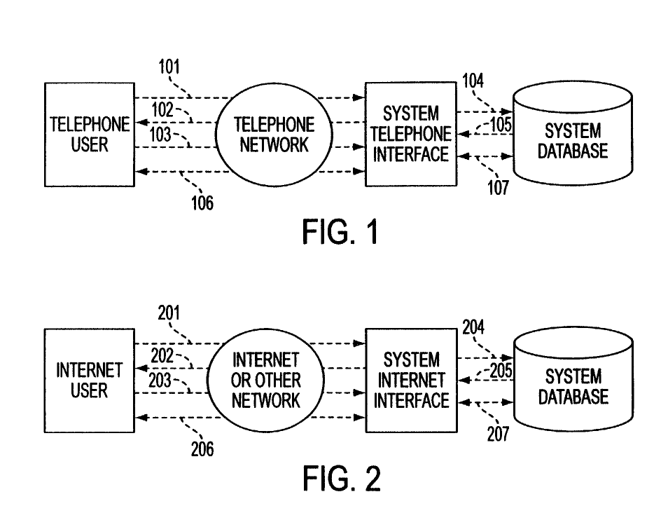

FIG. 1 is a flow diagram depicting telephone access embodiment of the present invention.

1. The user dials into the system, e.g., using an 800 number (Step 101).

2. The system prompts the user to enter the account number and the user's personal identification number (“PIN”), characteristics of the prompts, e.g., language and music, can be determined by the number dialed (step 102).

3. The user enters the account number and the PIN (step 103).

4. The system accesses the prepaid database to determine if the card, account, and PIN are valid, and the balance on the card (step 104).

5. The database notifies the system of the validity of the card and PIN, and the balance on the card. If the card is valid, the database also identifies the messages, tones, etc. to play for this user, based on their particular interests, preferences, and history (step 105).

6. The system interacts with the user based on the information in the database: either prompting the user for a valid account number and PIN, and limiting the user to “free” services if a valid account number and PIN are not entered; or interacting with the user to provide the services to which the user is entitled using the interface characteristics specified in the database, including whatever management features are provided (step 106).

7. The system accesses and updates the database to provide information about all the selections, services, and products selections requested by and made by the user (step 107).

8. Steps 106 and 107 may continue to alternate if the user chooses multiple interactions.

FIG. 2 is a flow diagram depicting an Internet access embodiment of the present invention.

1. The user employs the Internet to access the system, e.g., using a personal computer and a browser; the Internet address may be obtained from the prepaid card itself, from information given to the user over the telephone, or sent or told to the user using other means (Step 201).

2. The system prompts the user to enter the account number and the user's personal identification number (“PIN”); characteristics of the prompts, e.g., language, images, layout and music, can be determined by the Internet address entered (step 202).

3. The user enters the account number and the PIN (step 203).

4. The system accesses the prepaid database to determine if the card, account, and PIN are valid, and the balance on the card (step 204).

5. The database notifies the system of the validity of the card and PIN, and the balance on the card. If the card is valid, the database also identifies the messages, images, music, etc. to play for this user, based on their particular interests (step 205).

6. The system interacts with the user based on the information in the database: either prompting the user for a valid account number and PIN, and limiting the user to “free” services if a valid account number and PIN are not entered; or interacting with the user to provide the services to which the user is entitled using the interface characteristics specified in the database (step 206).

7. The System accesses and updates the database to provide information about all the selections, services, and products selections requested by and made by the user (step 207).

8. Steps 206 and 207 may continue to alternate if the user chooses multiple interactions.

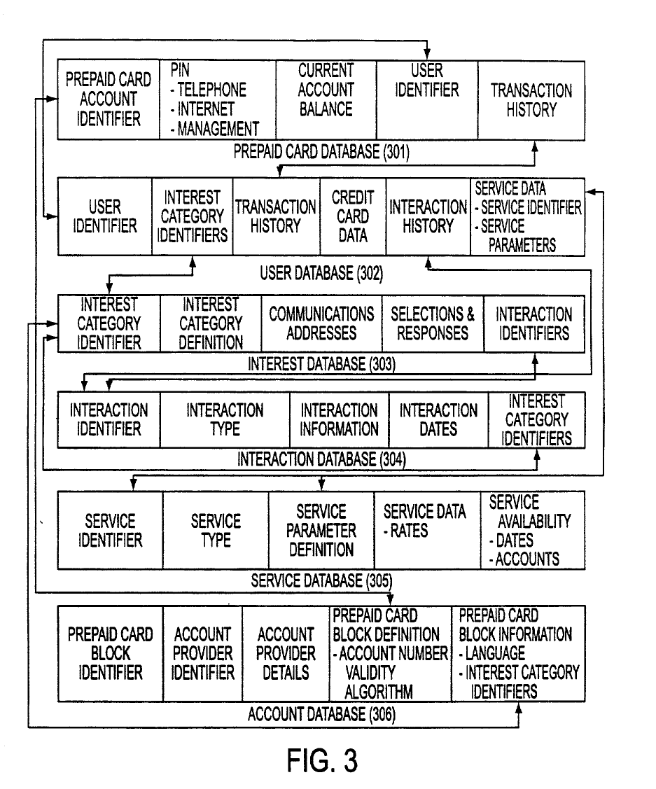

FIG. 3 is a schematic diagram of the database and information flow of an embodiment of the present invention.

For each prepaid card there is an entry in the Prepaid Card Database 301.

The Prepared Card Database 301 entries contain one or more of the data forms described below:

1. Prepaid Card Account Identifier

Each prepaid card has a unique account identifier associated with it, generally 9-20 digits, with shorter numbers being easier to “guess” for fraud, and longer numbers being harder for the user to remember and enter correctly. The form of the account identifier, such as the number of digits, and other restrictions on the values, are contained in a set of validity algorithms, corresponding to a particular provider set of accounts (see the Account Block Database 306 below).

2. PIN

A PIN, or personal identification number, is uniquely assigned to each prepaid card. Note for some cards this may be changed by the user. Separate PINs may be used for telephone access and Internet access, or they may be the same. A separate PIN for managing the account may also be provided.

3. Current Account Balance

The balance is the amount of money remaining to be spent in the prepaid card account. Typically this amount is set initially and then decremented with usage. A customer service aspect of the system is the option to credit the account in case of errors and other problems. Users may also be able to add value to the card either through a credit card or through purchasing value at a store, and following a procedure to add the value, either on the telephone or via the Internet.

4. User Identifier

More than one user may be allowed to use the account, in which case there may be multiple PINs, and thus multiple entries in the Prepaid Card Database 301. In other cases customers may purchase several prepaid cards and have the value consolidated into a single account. The User identifier allows consolidation or separation of accounts, see User Database 302 below.

5. Transaction History

As the account is used, a history of all the transactions may be maintained. The level of detail depends on the features to be provided. For example, if the service provider wants to allow the user to question why the value of their card has decreased by $30 since yesterday, the service provider may want to say a 35 minute call was placed yesterday at 8:30 pm to (809) 555-1212, and a 27 minute call this morning at 6:27 am to (808) 555-1212. This level of information is stored in the Transaction History. Similarly, credits, additions of value, or even just customer service interactions can be tracked in the Transaction History. Typically this information will “age off” and be deleted after a preset period, such as 90 days.

The User Database 302 identifies individual users and maintains the information corresponding to that user. In order to prevent this database from becoming extremely voluminous, methods may be used to summarize information and to group information to reduce the stored volume. The User Database 302 entries for each user may contain one or more of the data forms described below:

1. User Identifier

The User Identifier data uniquely identifies each user. Several different prepaid cards may be used by the same user, or several users may use the same prepaid card. The User Identifier is what allows the system to associate all transactions with a particular user. Where several users employ the same prepaid card or where one user can employ several prepaid cards, an access system may provide a mechanism for the users to identify themselves and the prepaid card, which maintains the monetary value, for example the same Prepaid Card Account Identifier may have several entries with different PINs. Other methods may also be employed to correlate that different Prepaid card accounts may apply to the same user, or that other types of activity, such as purchases using a credit card directly, may apply to the same user, in some cases with only a probability less than one, which can also be recorded.

2. Interest Category Identifiers

An important aspect of the invention is identifying the interests of each user. Each user database record contains a list of the interest categories for that particular user. The values here are pointers to the interest categories reflected in the Interest Database 303.

3. Transaction History

Each time the user purchases something using the card or performs another significant transaction, a record of that transaction is placed in the user's record. This permits effective management of the account; for example if the user requests a refund the transaction record will show whether such a purchase was in fact made, and the details of the purchase. This information aids in determining the characteristics of the user, for example, how much money they spend each month in each category of purchases.

4. Credit Card Data

The user may be able to add value to the prepaid card, either when the user is notified that the value is running out, or automatically when the balance drops below a certain value. The information required about a credit card, or other fund source, to perform these increments to the value of the prepaid card, such as the credit card number, expiration date and other authorization data can be stored here.

5. Interaction History

A variety of information is presented to the user in various forms. The purpose of the Interaction History is to keep track of what has been presented, when, and the user's reaction to the information presentation. A pointer to an Interaction Identifier in the Interaction Database 304 is entered, along with the date and time of presentation, user responses, and optionally other information as described below. The telephone interface will be playing specific announcements to the user at various times during placement of calls. In order to prevent repeating announcements too frequently, as well as to aid in determining the effectiveness of particular announcements, a record is keep of announcements played, and when they were played. These can then be correlated with the user's reactions, including purchases and other transactions. Similarly, on the Internet interface, a variety of targeted information may be displayed to each individual user. To control the repetition of that information and to determine the effectiveness of those information displays, a record is made of each piece of information displayed and the time of its display. These can then be correlated with purchases and other transactions.

A variety of opportunities are available for display of information, products and services to the user, for example over the Internet, sent to the user's house or business, in print media, or in stores and other physical locations frequented by the user. A record is kept of the information, services and products displayed to each user when the user is identified, and the time of the display. These can then be correlated with purchases and other transactions. With many media and physical locations, it is not possible to determine that a particular user actually saw or interacted with a particular display, so a probability may be provided that a user may have seen or interacted with the information, product or service. The information here may become too voluminous to keep in it full detail, so methods may be employed, such as encoding a whole sequence of interactions as a single entry in the Interaction Database, and then a start and end time kept, in which case the actual time of display of each component is not known. Similarly, only selected interactions may be recorded, or sample users recorded in detail, and others generally. Also, once the data have been analyzed, much of the data may be deleted, summarized, or archived, with only selected user data saved for more detailed subsequent analysis. Service Data

Many different services may be provided through the overall system, and an individual user typically only has access or selects one or a few of them. The Service Data describes the services a user has access to by pointing to the specific Service Identifiers in the Service Database (305). Each of these services may have many options and features, and the specifics of each user are defined in the Service Parameters, also in the Service Database (305). Additional information, such as the dates the user started and stopped subscribing to a particular service can be included.

One particularly advantageous aspect of the present invention is the identification of specific interests of users. The Interest Database 303 lists the interest categories, such as individual sports, countries, languages, etc. and matches fees to the various information elements that are available directly or indirectly about the user. The Interest Database 303 may contain one or more of the data forms described below:

1. List of Interest Category Identifiers

Each category of interests is listed and described as a record in this database.

2. Interest Category Definition

Each Interest Category is defined. In order to manage the database, the system may process the interest categories so that one category may be separated into multiple categories or multiple categories may be combined together, as new information and usage determines the appropriateness of finer or coarser categorization; for example, a single soccer team in a country may split into multiple teams and then a whole league, or interest in a team may grow so that the individual players need to be tracked. The database may contain additional records showing the relation and time evolution of these categories.

3. Communications Addresses Mapping to Interests

The telephone numbers called, durations of the calls, and selections made on those numbers using a prepaid card may provide a wealth of information about the countries and areas called, as well as specific services, such as a Brazilian soccer fan number. Similarly Internet Addresses visited, including the time spent and selections made at those sites provide significant information about the interests of the user. This portion of the database may include the algorithms, parameters, and if necessary, individual numbers and addresses, to map to interest categories.

4. Selections & Responses

As the user accesses information, products, and services via communications, such as telephone and the Internet, the specific selections made may indicate interests. This portion of the database maps those selections to specific interest categories. Specific questions may be asked of the user over the telephone to identify interest. The records in this portion of the database identify the specific questions and mapping of those to specific interests. Similarly, specific questions may be asked of the user over the Internet to identify interest. Again, the records in this portion of the database identify the specific questions and mapping to specific interests.

The system, and more generally the whole operation may interact with a user in many different ways. The Interaction Database 304 maintains entries describing potential interactions with users, and may contain one or more of the data forms described below:

1. Interaction Identifier

A unique identifier for each interaction defined.

2. Interaction Type

Many different types of interactions may be included in the database, such as announcements, information, services, and products which are addressed through any of the display mechanisms to the user, including telephone, Internet, print media, human interaction, physical display, and physical delivery.

3. Interaction Information

Information about each of the items, such as a description, or the actual content, of the item, and other information to categorize and characterize the interactions are described here. When responses are required or anticipated by the user, the choices for user responses are described here, and this may include specific data elements of types of choice and specific responses; user responses can also be included in the Transaction History, as appropriate. Where a variety of items are always provided having similar characteristics, these items may be lumped together as a single item for tracking in the other databases, even though they may be distinguished in the Services Database 305. Categories of items may also be included, for example, relating to a particular sport, country, service, or language, these are useful in correlating data, and also reducing the volume of data in the individual user records.

4. Interaction Dates

The date the item became available, the date the item was no longer available, dates of changes, are included here. Variations in the items may be reflected in the same entry with dates shown for changes.

5. Interest Category Identifiers

Interactions are often linked to specific interests, and thus each Interaction may list one or more Interest Category Identifiers in the Interest Database 303.

The Service Database 305 identifies and defines the services, information, products and other items available to the users through the system. The Service Database 305 entries for each user may contain one or more of the data forms described below:

1. Service Identifier

Each service, information, products and other items are identified uniquely.

2. Service Type

Each service, information, products and other items is defined, in technical, operational, and descriptive terms.

3. Service Parameter Definition

Each service, information, products and other items can have a variety of parameters, which are defined here. For example, the user may be able to have a speed dial list, so the definition of the entries, such as speed dial codes and corresponding numbers to be called must be defined. Or the user may have a specific set of information and a look and feel for their information display on the Internet, which would be defined here, including choices of what sports information to display and where.

4. Service Data

Each service, information, products and other items will have specific data relating to the service, such as charging rates which are needed to process the use of the service, etc. For example, a charge per minute as a function of country called, or the charge per movie viewed over the Internet, or the charge for shipping for physical items, etc.

5. Service Availability

The date when a particular service, information, products and other item becomes available for use, and the date it is no longer available is specified.

The prepaid accounts are grouped together into blocks, which have common characteristics, for example, a common service provider. These block are defined in the Account Database 306. The Account Database 306 entries for each user may contain one or more of the data forms described below:

1. Prepaid Card Block Identifier

The unique identifier for each prepaid account block is listed.

2. Account Provider Identifier

The unique identifier for each prepaid account provider is defined.

3. Account Provider Details

The details of each prepaid account provider, such as billing information, are provided here.

4. Prepaid Card Block Definition

The mapping of prepaid accounts to card blocks is defined here. Typically this is an algorithm, such as a consecutive block of numbers, although security algorithms may be included so that only selected numbers are valid to help prevent fraud by guessing account numbers. The physical prepaid cards may contain information such as a language, country, a targeted set of customers, an affiliation (such as club, political party, profession, religion), a sport or other interest topic, and thus the individual cards need to be mapped to specific interest categories.

5. Prepaid Card Block Information

Each Prepaid Card Block has matching characteristics, such as language or languages for providing interactions and information, mapping to Interest Category Identifiers, in the Interest Database 303, and other characteristics.

For example, a card block may represent a French language interface with a focus on a particular soccer team; typically the physical card would then have the instructions and information in French, and would have a picture or other information about the particular soccer team, and often these cards are collectable.

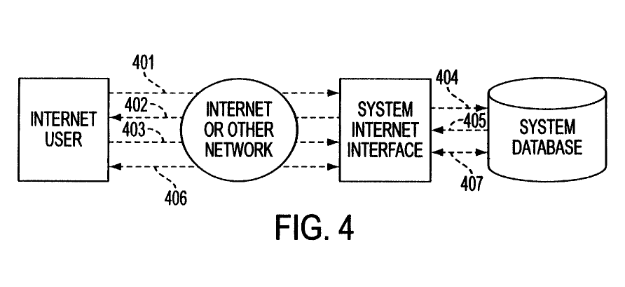

FIG. 4 is a flow diagram depicting an embodiment of the present invention for the user to manage the prepaid account using Internet access.

1. The user employs the Internet to access the system, e.g., using a personal computer and a browser; the Internet address may be obtained from the prepaid card itself, from information given to the user over the telephone, or sent or told to the user using other means (Step 401).

2. The system prompts the user to enter the account number and the user's personal identification number (“PIN”); characteristics of the prompts, e.g., language, images, layout and music, can be determined by the Internet address entered (step 402).

3. The user enters the account number and the PIN (step 403).

4. The system accesses the prepaid database to determine if the card, account, and PIN are valid, and the balance on the card (step 404).

5. The database notifies the system of the validity of the card and PIN, and the balance on the card. If the card is valid, the database also identifies the messages, images, music, etc. to play for this user, based on their particular interests (step 405).

6. One of the options available to the user is to manage the account. This may, optionally, require a separate management PIN, which may be different from the PIN to access the services, to provide additional security. The system prompts the user for the management PIN, if present. The user enters the PIN, if required. The system interacts with the user based on the information in the database: either prompting the user for a valid management PIN, and denying access to management capabilities if a valid management PIN is not entered; or providing the management capabilities to which the user is entitled using the interface characteristics specified in the database (step 406).

7. The System accesses and updates the database corresponding to the management options available to the user and the actions taken by the user (step 407).

Steps 406 and 407 may continue to alternate if the user chooses multiple management optioins.

It will be understood that the above-described embodiments are merely illustrative of the principles of the invention and that other arrangements may be devised by those skilled in the art without departing from the spirit and scope of the invention.

What is claimed is:

1. A method of managing a prepaid card account to provide offers for goods or services in real time to a user of the prepaid card via a first electronic communications device, comprising the steps of:
establishing a communication via the device between the user and a first provider of goods or services;
receiving, by said first provider, of the user's prepaid card account number via the first device;
notifying a prepaid card manager, by said first provider, of said transmission of said prepaid card account number via a second electronic communications device;
selecting by said prepaid card manager an offer of a good or service based on information an interest database maintained by said manager, said interest database corresponding to said prepaid card account; and
transmitting said offer from said prepaid card manager to said user via said first device.

2. The method of claim 1 wherein said first device is a telephone.

3. The method of claim 1 wherein said first device is a computer.

4. The method of claim 1 wherein said first and second devices are of substantially the same form.

5. The method of claim 1 further comprising the step of entering, by said user, information into said interest database.

6. The method of claim 1 further comprising the step of storing in said database, by said manager, of data relating to communications, between said user and at least one second provider of goods or services, via a third electronic communications device.

7. The method of claim 6 wherein one of said second providers is said first provider.

8. The method of claim 6 wherein said third device is a telephone.

9. The method of claim 6 wherein said third device is a computer.

10. The method of claim 6 wherein said first and third devices are of substantially the same form.

11. The method of claim 1 wherein said interest database includes information sorted according to a category selected from the group consisting of sports, countries, affiliations, and languages.

12. The method of claim 11 wherein said offer is transmitted in a language selected from a language stored in said interest database.

13. The method of claim 1 further comprising storing, by said manager, of information corresponding to the content of said offer in an offer database.

14. The method of claim 1 further comprising storing, by said manager, of information corresponding to an indication of whether the user accepted said offer in an offer database.

15. The method of claim 1 further including selecting said offer based on information stored in an offer database.

16. The method of claim 15 further comprising selecting said offer based on whether an offer having substantially the same content was previously made to the user.

17. The method of claim 15 further comprising selecting said offer based on whether an offer having substantially the same content was previously accepted by the user.

18. A prepaid card account manager comprising:
a prepaid card database including at least a balance and account number for at least one prepaid card
an interest database corresponding to said account number; and
an offer database.

19. The manager of claim 18 further including an offer generator for selecting an offer from said offer database based on information in said interest database and transmitting said offer to a user of said prepaid card via an electronic communications device.

20. The manager of claim 18 wherein said interest database includes information sorted according to a category selected from the group consisting of sports, countries, affiliations, and languages.

21. The manager of claim 19 wherein said telecommunications device is a telephone.

22. The manager of claim 19 wherein said telecommunications device is a computer.

23. The manager of claim 19 further comprising an offer selector for selecting an offer based on information is said offer database.

24. The manager of claim 23 wherein said offer database includes information corresponding to the content of offers.

25. The manager of claim 23 wherein said offer database includes information corresponding to whether an offer was accepted by said user.

26. The manager of claim 23 wherein said offer database includes information corresponding to whether an offer was accepted by said user.

27. A system for managing a prepaid card account comprising:
means for identifying the prepaid card account;
means for storing interests of a user of the account; and
means for generating an offer of goods or services based on said interests, said offer generated during a electronic communication between said user and a provider of goods or services.
